(19) United States
(12) Patent Application Publication
(10) Pub. No.: US 2006/0132564 A1
(43) Pub. Date: Jun. 22, 2006

(54) Meltable ink suitable for use in an inkjet printer provided with a carbon duct plate

(75) Inventor: Marcus Petrus Leonardus Huinck, Herten (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/354,863

(22) Filed: Feb. 16, 2006

Related U.S. Application Data
(63) Continuation of application No. PCT/NL03/00588, filed on Aug. 18, 2003.

(51) Int. Cl. B41J 2/175

(52) U.S. Cl. 347/88

(57) ABSTRACT

A meltable ink which is solid at room temperature and liquid at elevated temperature, used in combination with an inkjet printhead for the image-wise transfer of the ink to a receiving material, wherein the printhead contains a number of ink ducts, each ink duct leading to an opening for jetting ink drops from said duct, which ducts are formed in a duct plate made basically of carbon, whereas the ink can penetrate into the carbon in such manner that if an element made from said carbon is enclosed by the ink for about 20 hours at a temperature of about 130° C. said element has an increase in mass of more than 1.5%.

This application claims priority under 35 U.S.C. § 120 to International Application No. PCT/NL03/00588 filed on Aug. 18, 2003. The entire contents of the above application is hereby incorporated by reference.

### BACKGROUND OF THE INVENTION

The present invention relates to a meltable ink which is solid at room temperature and liquid at elevated temperature, used in combination with an inkjet printhead for the image-wise transfer of the ink to a receiving material, wherein the printhead comprises a number of ink ducts, each ink duct leading to an opening for jetting ink drops from said duct, said ducts being formed in a duct plate made basically from carbon.

A combination of an inkjet printhead with a carbon duct plate and a meltable ink known as a hot melt ink or phase change ink is known from European Patent EP 0 699 137. From this patent it is known that it is advantageous, if carbon is used as the basic material for the duct plate, so as to make the duct plate impermeable to the ink used. In other words it is advantageous to use a combination of duct plate and ink such that the ink cannot penetrate the material of the duct plate. For this purpose, for example, it is possible to select a type of carbon which is impenetrable to the ink. The patent specification proposes to treat the surface of the duct plate so that said plate becomes impenetrable to the ink. The application of a coating impenetrable to the ink is particularly proposed.

Experiments in the use of such a printhead in an inkjet printer, however, show that the jetting properties of this printhead, i.e., the functional properties of the inkjet head which determine the way in which ink drops are jetted from the ink duct, are not optimal. For example, ink drops with an unwanted small or large volume can be jetted from the opening in the duct. A volume deviation of this kind is not necessarily noticed in the printed image, although when high image quality is required a volume deviation can be found to be disturbing. Another deviation which may be the result of poor jetting properties is the entire absence of an ink drop at the time that the corresponding ink duct is actuated. This deviation will result mainly in disturbing artefacts. Also it sometimes happens that an unwanted satellite drop emerges from the duct directly prior to or following the intended drop. It is also frequently seen that drops are jetted from the opening at a wrong angle or that they emerge from the opening without being jetted and thus merely flow out along the opening. In this situation the printhead becomes soiled on the side where the openings are located and can thus soil a receiving material.

### SUMMARY OF THE INVENTION

Thus, the object of the present invention is to provide an ink which, in combination with a printhead having a carbon duct plate obviates the above-described disadvantages. To this end, the known combination of a meltable ink and a printhead is improved, an ink being selected which can penetrate the carbon in such manner that if an element made from this carbon is enclosed by the ink for about 20 hours at a temperature of about 130° C. said element has an increase in weight of more than 1.5%.

It has been surprisingly found that when an ink of this kind is used very good jetting properties can be obtained. It is entirely unexpected that it appears to be advantageous for the ink to migrate into the carbon duct plate but only in an amount of at least 1.5% under the above-described conditions. If less ink is drawn in, there is no appreciable improvement of the jetting properties. In addition, the problem of deviant drop volumes is substantially eliminated. The reason for this is not clear but might be related to better wetting of the walls of the ink ducts with the ink. Better wetting can reduce the problem of air bubbles which adhere to the wall of the duct. It is generally known that such air bubbles have an adverse effect on the jetting properties of a printhead. It should also be clear that there is no need for the entire duct plate to be made from carbon in order to utilise the advantages of the present invention. Duct plates in which, in particular, those parts of the duct plate which are in contact with the ink, are made mainly from carbon, certainly are contemplated to fall within the scope of the present invention. If required, those parts can be provided with a physical and/or chemical surface treatment such as is generally known.

In one embodiment of the present invention the increase in weight in the case of penetration of the ink under the above conditions is between 2.5 and 3%. If inks migrate into the carbon excessively, i.e., if there is an increase in the mass of the carbon duct plate greater than 3%, then adverse effects occur. On the one hand, the jetting properties are not found to improve further. The reason for this is not clear but could be related with the fact that a considerable quantity of ink in the duct plate influences the thermal and mechanical properties of said plate. On the other hand, in this case, it appears that the inks themselves will migrate into the duct plate so intensely that they will soil the outside of the duct plate. Since at least one outside of said plate is often also an outside of the printhead, this results in comparable problems to those known from the prior art. Quite unexpectedly it has been found that at the top of the range found, namely with an increase in mass between 2.5 and 3%, there is a range where the jetting properties are very good. In this embodiment, the required start-up time for the printer is short. This means that a rapid start can be made with printing after the printhead has filled with ink.

In another embodiment of the present invention the ink comprises a crystalline basic material and an amorphous binder. Commercially available inks frequently do not contain crystalline materials because they can result in opaque inks which are also very brittle and hence relatively easy to remove from a receiving material by mechanical operations such as gumming, scratching and folding. It has been found that such crystalline materials, if combined with an amorphous binder, result in a further improvement of the present invention. This is despite the fact that the penetration of a mixture of substances normally results in chromatography effects which, in principle, could be disadvantageous in the present invention. Surprisingly this has not been found.

In another embodiment, the present invention relates to a meltable ink for use in an inkjet printhead wherein the ink ducts can be controlled by the use of piezo-electric actuators operatively connected to the ducts via a vibration plate. In this embodiment, the penetration of the carbon in the duct plate results in particularly advantageous properties. Possibly the penetration of ink into the duct plate results in an even better co-ordination of the respective material properties between the carbon and the piezo-electric material. This not only promotes the jetting properties but also lengthens the printhead life.

The present invention also comprises the use of an ink in a printhead provided with a carbon duct plate and the use of a meltable ink composition for producing solid ink units for use in an inkjet printer.

### BRIEF DESCRIPTION OF THE DRAWINGS

The invention will now be further explained with reference to the following drawings and examples:

FIG. 1 is a diagram showing an inkjet printer.

FIG. 2 is a diagram showing the construction of a printhead for an inkjet printer.

FIG. 3 shows a rig for making solid ink units.

FIG. 4 shows a rig for determining the penetration of ink into the carbon.

FIG. 5 shows the penetration of meltable ink into carbon.

Example 1 shows a number of inks and carbons according to the invention.

Example 2 gives a number of inks for comparison.

Example 3 describes the method of making a basic component for a meltable ink.

### DETAILED DESCRIPTION OF THE INVENTION

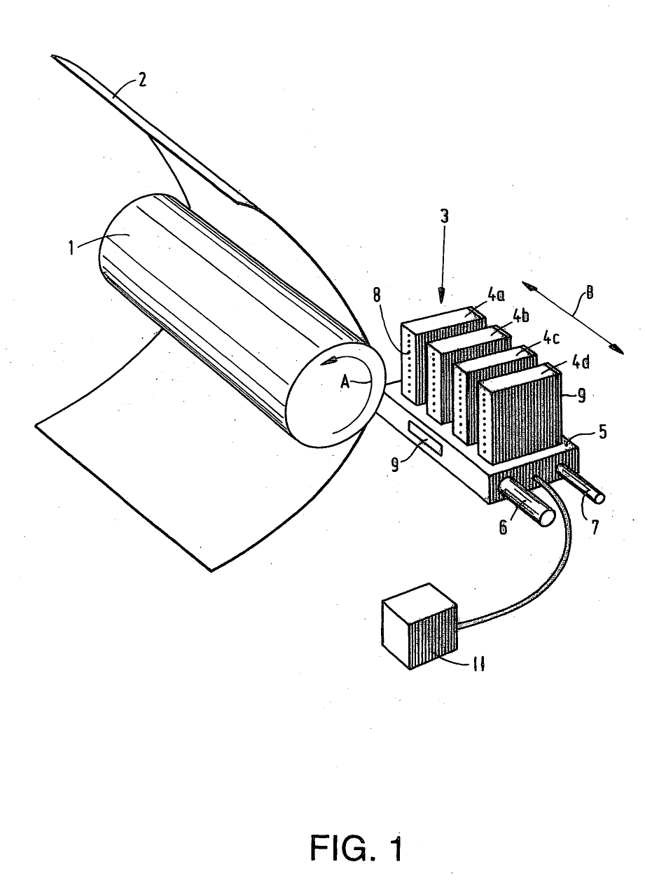

FIG. 1 diagrammatically illustrates an inkjet printer. In this embodiment, the printer comprises a roller 1 for supporting a receiving material 2, for example a sheet of paper or a transparent sheet, which is moved along the scan carriage 3. This carriage comprises a carrier 5 on which the four printheads 4a, 4b, 4c and 4d are fixed. Each printhead is provided with ink of its own color, in this case cyan (C), magenta (M), yellow (Y) and black (K) respectively. The printheads are heated by heating means 9 disposed at the back of each printhead 4 and on the carrier 5. In addition, temperature sensors (not shown) are mounted on the carriage. The printheads are maintained at a correct temperature by means of a control unit 11, with which the heating means can be controlled individually in dependence on the temperature measured with the sensors.

The roller 1 is rotatable about its axis as shown by arrow A. In this way, the receiving material can be moved in the sub-scanning direction (X-direction) with respect to the carrier 5 and hence also with respect to the printheads 4. The carriage 3 can be moved in reciprocation by suitable drive means (not shown) in a direction indicated by the double arrow B, parallel to roller 1. For this purpose, the carrier means 5 is moved over the guide rods 6 and 7. This direction is termed the main scanning direction or Y-direction. In this way the receiving material can be completely scanned with the printheads 4. In the embodiment shown in FIG. 1, each printhead 4 comprises a number of internal ink ducts (not shown) each provided with its own exit opening or nozzle 8. In this embodiment the nozzles form one row per printhead, perpendicular to the axis of roller 1 (the sub-scanning direction). In a practical embodiment of an inkjet printer, the number of ink ducts per printhead will be many times greater and the nozzles will be distributed over two or more rows. Each ink duct is provided with a device (not shown) whereby the pressure in the ink duct can be suddenly increased so that an ink drop is ejected by the nozzle of the associated duct in the direction of the receiving material. According to this example, this device comprises, in the printhead, a piezo-electric element which is so constructed that it can be actuated image-wise by an associated electric drive circuit (not shown). In this way an image can be built up from ink drops on the receiving material 2.

When a receiving material is printed with a printer of this kind, in which drops are ejected from ink ducts, the receiving material, or part thereof, is (imaginarily) divided up into fixed locations which form a regular field of dot rows and dot columns. In one embodiment, the dot rows are perpendicular to the dot columns. The resulting separate locations can each be provided with one or more ink drops. The number of rotations per unit length in the directions parallel to the dot rows and dot columns is termed the resolution of the printed image, for example, indicated as 400×600 d.p.i. (dots per inch). By controlling a row of nozzles of a printhead of the inkjet printer image-wise when the same moves with displacement of the carrier means 5 with respect to the receiving material, there forms on the receiving material, at least on a strip in the width of the length of the nozzle row, a (sub-)image built up of ink drops.

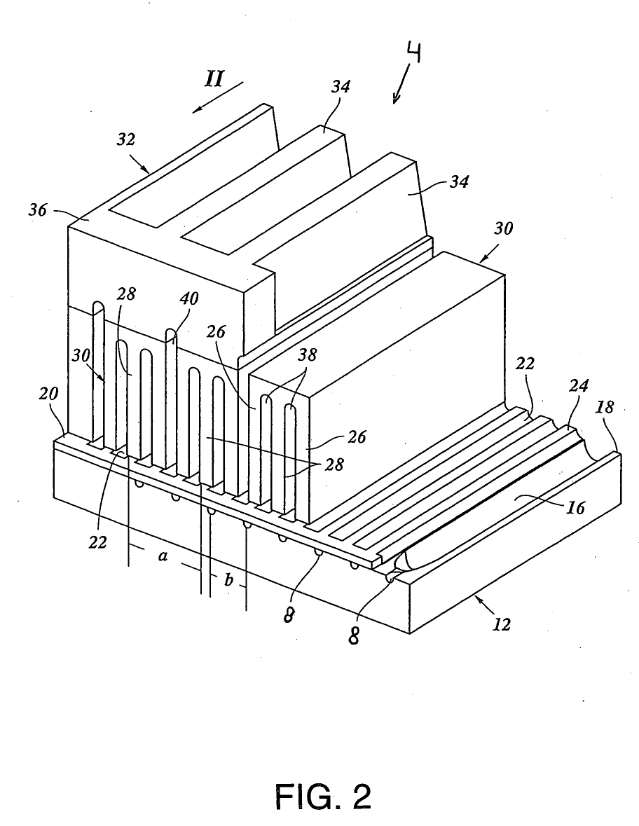

FIG. 2 is a diagram showing a printhead 4 comprising a carbon duct plate 12 and piezo-electric elements 30. The duct plate contains ink ducts 16 laterally defined by walls 18. At the front of the printhead each of the ink ducts terminates at a nozzle 8. At the top the duct plate is covered by a vibration plate 20 so that the ink ducts are substantially closed. In this embodiment the vibration plate 20 contains dams 24 and grooves 22.

At the top, the printhead is bounded by a carrier element 32 which comprises longitudinal members 34 having a trapezoidal cross-section. The piezo-electric blocks 30 are fixed on the underside of the carrier element 32. The blocks 30 comprise fingers 26 and 28 formed by milling grooves 38 and 40 in the piezo-electric material. The grooves 38, which separate the fingers 26 and 28 from one another, terminate in the piezo-electric material, while the grooves 40 which separate the blocks 30 from one another continue into the carrier element 32 so that they also separate the longitudinal members 34 from one another. The width of the longitudinal members 34 is thus substantially equal to the width of the separate blocks 30. As a result, the member 34 efficiently prevents the top part of the blocks 30 from distorting elastically during the expansion and contraction of the piezoelectric actuators 26. Since, in fact, carrier element 32 consists of separate members 34 interconnected only at the parallel sides by the cross-members 36, and since these cross-members are also weakened by the grooves 40, the bending forces are confined mainly to the blocks 30 where they originate. In this way cross-talk can successfully be suppressed over a considerable distance. In the embodiment illustrated, the width of the grooves 40 is equal to the width of the grooves 38, and the fingers 26, 28 are equally spaced. The pitch a of the support elements 28 is larger by a factor 2 than the pitch b of the nozzles 8. Since every third finger is a support element 28, the pitch of the fingers 26 and 28 is equal to 2b/3. Consequently, pitch b of the nozzles and hence the resolution of the printhead can be made small without exceeding the limits for the piezo-electric actuators and support elements as imposed by the production process. In one practical embodiment, pitch b of the nozzles 8 can preferably be 250 μm (i.e., four nozzles per millimeter). The pitch a of the support elements 28 will accordingly be 500 μm and the pitch of all the fingers (including the actuators 26) 167 μm. In this case, the width of each separate finger 26 or 28 can, for example, be 87 μm and the grooves 38, 40 will have a width of 80 μm and a depth of about 0.5 mm.

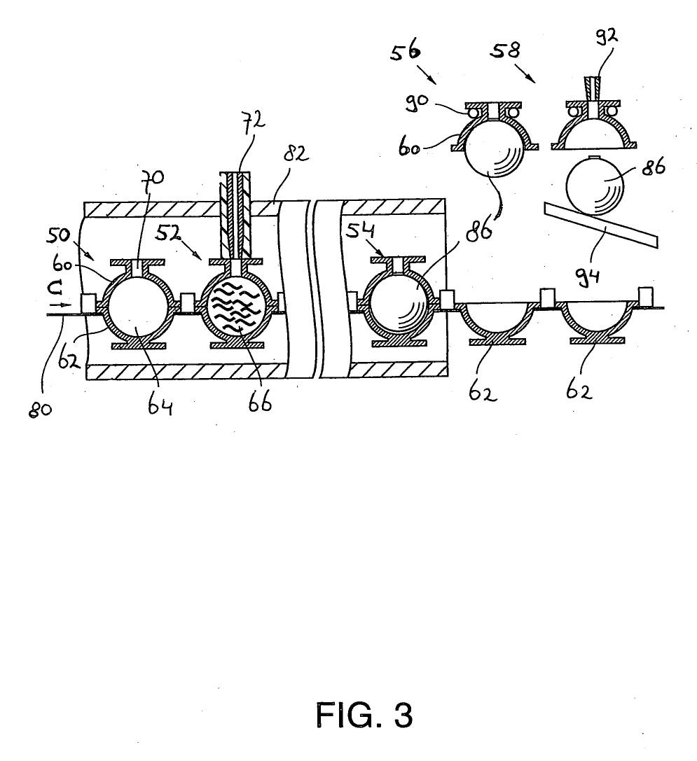

FIG. 3 is a diagram showing a method by means of which solid units of a meltable ink can be made. A number of moulds 50, 52, 54, 56 and 58 are shown each comprising a top part 60 and a bottom part 62. These parts together form a cavity 64 filled with meltable ink 66. The top part 60 includes a filling opening 70 so that liquid ink can be introduced into the cavity 64 by means of filler elements 72.

The bottom parts 62 of the moulds are carried by a belt 80. The belt takes the moulds 50-58, one by one, in the direction C through a chamber 82 in the form of a tunnel. As soon as a mould stops level with the filling element 72 (mould 52 in FIG. 3), the filling element is connected to the filling opening 70 and the melted ink 66 flows into the cavity 64. As soon as the cavity is completely filled the belt 80 moves on one step so that the next mould can be connected to filler element 72.

When the solid ink unit 86 is completely set, the mould leaves the chamber 82. The top part 60, as indicated for the moulds 56 and 58, is then removed by gripper element 90. Unit 86 remains stuck to the top part 60. To remove ink unit 86 a nozzle 92 is placed on the top part 60, whereafter the unit is blown out of the top part by means of compressed air. The unit 86 is collected and transported on by element 94. This method is described in detail in European Patent Application EP 1 260 562.

The present example shows how it is possible to determine the degree to which a meltable ink penetrates carbon. For this purpose use is made of a controllable oven 100 provided with a control unit 113. The oven is operated under normal pressure (1 atmosphere) and air humidity (60%) and can be closed by a door 107. The oven contains a glass beaker 101 filled with ink 110. The temperature of the rig is maintained at 130° C. For this purpose, a thermocouple 112 is disposed in the ink and is operatively connected to the control unit 113. At the top, the glass beaker is closed by lid 102 (the central part of the lid has been omitted from the drawing for the sake of clarity). Disposed in the lid is a holder 103. A flexible cord 104 is fixed to the holder and by means of this cord an element 105 made from carbon can be held suspended in the ink.

For this test use is made of an element 105 made from carbon of type SGL 5710 by Messrs SGL Carbon AG (Wiesbaden, Germany). The element is rectangular and has a length and width of 3 cm, and a height of 2 cm. In this way the element has a volume of 18 cm³ and an area of 42 cm². An element of this kind is made by milling it from a larger piece of carbon. After milling, the element is cleaned in an ultrasonic cleaning bath filled with demineralized water. The element is removed from the bath by means of a gripper, whereafter the cord 104 is applied to fix the element 105 to the cord. The element 105 is then rinsed with demineralized water. The test is carried out by suspending the element 105 in the ink as indicated in the drawing. After a predetermined time the element is removed from the ink and, while still warm, is cleaned with a fiber-free cloth of the kind normally used in clean rooms, for example a cloth of type alphawipe TX 1004 made by Messrs Texwipe. The element is then allowed to cool to room temperature in a clean environment, whereafter the element is weighed. In this way it is possible to determine the increase in the mass of the element. The test can then be continued by suspending the element 105 in the ink again.

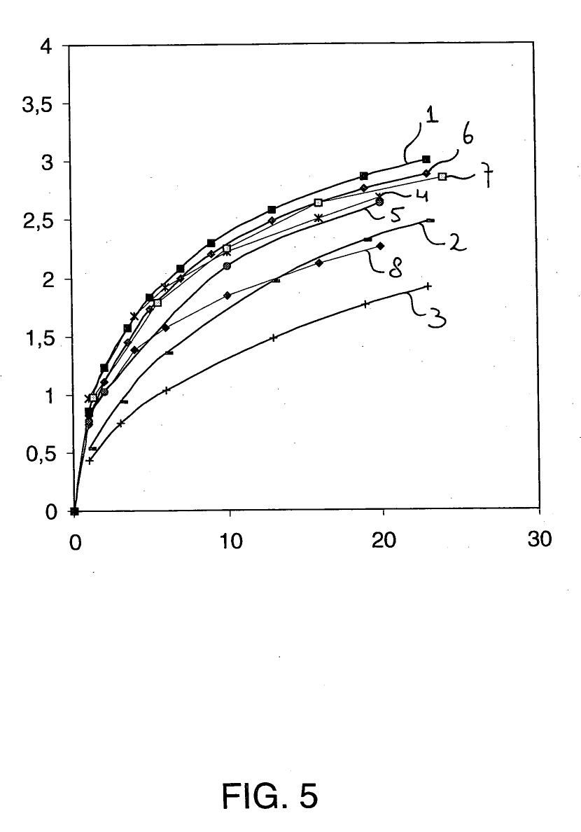

In this way, inks are tested as indicated below under Example 1. FIG. 5 shows how the inks migrate into the carbon. It can be seen that these inks migrate into the carbon comparably and all result in an increase in mass, at least after 20 hours, greater than 1.5%. If an ink is tested which results in the above-described disadvantages as known from the prior art, then it falls outside the indicated range. If the inks of Table 2 are tested it will be apparent that they cause practically no measurable increase in mass of the carbon test block. The degree of penetration of the ink cannot be predicted on the basis of physical and/or chemical properties of carbon and ink. Nor can the invention be simply attributed to the porosity of carbon. If that were the case, then the increase in mass would have to be approximately the same in all inks having substantially the same density, in tests with the same type of carbon. It should also be noted that if an ink in the above-described test with the element described therein results in an increase in mass of more than 1.5%, this ink in printheads in which use is made of another type of penetratable carbon can also result in good jet properties. Apparently a complex set of factors is important in this process and these factors in turn are related to the jet properties of the printhead. A small change in a basic component of the ink or the quantity of this basic component may have an appreciable effect on the penetration of this ink into the carbon. An important advantage of the present invention is that inks can be examined beforehand, by a simple readily controllable test, for possible suitability for use in a printhead having a carbon duct plate. The test has also been carried out with an element having different dimensions than those of the above described element, namely 2×2×3 cm (I×b×h). It was found that the difference in the increase in weight between the two blocks under the described conditions was negligibly small.

FIG. 5 shows the penetration of meltable ink into carbon diagrammatically. The vertical axis shows the increase in mass (in percentage with respect to the initial mass) of the element 105. The horizontal axis shows the dwell time of the element in the ink (in hours). The eight curves 1 to 8 show the penetration of eight inks 1 to 8 in accordance with Example 1.

Table 1 gives a number of examples of inks, at least the meltable fraction (or carrier fraction or basic components) of these inks, which are solid at room temperature and liquid at elevated temperature, which inks in combination with duct plate made mainly from carbon, for example of the type shown in FIG. 2, result in a printhead having good jetting properties. In practice, there are added to these inks substances such as pigments, dyes, viscosity controllers, surfactants, stabilisers and so on. Small additions of such substances do not appreciably influence the penetration behaviour of the ink in the carbon. The indicated percentages are percentages by weight.

TABLE 1
MELTABLE INKS THAT CAN BE USED ACCORDING
TO THE PRESENT INVENTION.

| Ink No. | Composition |
|---|---|
| 1 | 60% of compound 8, Table 3 of Netherlands Patent NL 1017049 |
| | 40% of the compound according to Example 3. |
| 2 | 70% of compound 13, Table 2, of Netherlands Patent NL |
| | 1012549 |
| | 17.5% Epikote P (Shell, Netherlands) |
| | 12.5% Ketjenflex MH (AKZO, Netherlands) |
| 3 | 70% of compound 18, Table 4 of Netherlands Patent NL |
| | 1017049 |
| | 15% Epikote P (Shell) |
| | 5% Cellolyn 21e (Hercules) |
| | 10% of compound 13, Table 2 of Netherlands Patent NL |
| | 1012549 |
| 4 | 90% of compound 8, Table 3 of Netherlands Patent NL 1017049 |
| | 8% Epikote P (Shell) |
| | 2% Ketjenflex MH (AKZO) |
| 5 | 85% of compound 8, Table 3 of Netherlands Patent NL 1017049 |
| | 5% Epikote (P) Shell |
| | 10% Foralyn 110 (Hercules) |
| 6 | 75% pentaerythritol tetrabenzoate |
| | 20% Crystalbond 509 (Printlas) |
| | 5% para-n-butylbenzenesulphonamide |
| 7 | 60% 1,8 octanediol |
| | 40% Kristalflex F100 (Eastman Chemical Corp). |
| 8 | 80% para-n-butylbenzenesulphonamide |
| | 20% Sunmide 550 (Sanwa Chemical) |

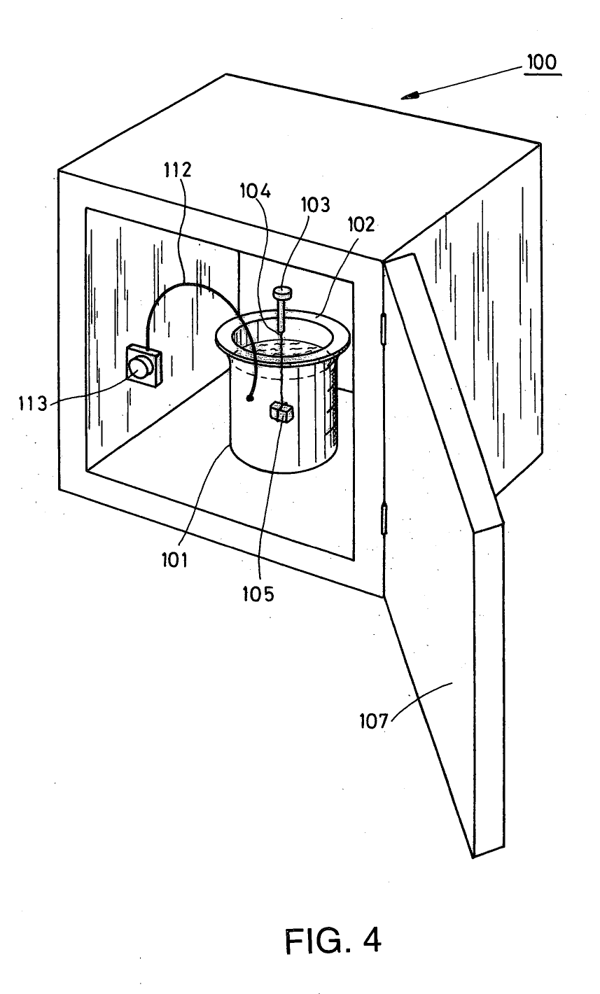

Carbons that can be used in the present invention are adapted to penetration by the meltable inks. Examples of such suitable carbons (or graphite) are TS 5223 of Messrs UCAR (France), UTR 85 of Messrs Xycarb (Netherlands), G1300 made by Messrs Intech (Netherlands), EY 365 of Messrs Morganite (Luxembourg), SGL 5710 of Messrs SGL Carbon (Germany) and Ellor+50 of Messrs Carbonne Lorraine (France). Whether a carbon of this kind really can be used according to the present invention depends on the interaction of this carbon with the ink which is to be printed using a duct plate made from that carbon. This must be determined experimentally for each possible combination of ink and carbon. A method of determining this is described in connection with FIG. 4.

Table 2 shows a number of inks, or at least the meltable fraction thereof, which in combination with the carbon duct plate result in a printhead having unacceptable jet properties.

TABLE 2
INKS AS COMPARATIVE EXAMPLE.

| Ink No. | Composition |
|---|---|
| 11 | Ink according to Example 32 of U.S. Pat. No. 6 018 005 |
| 12 | 60% para-toluene sulphonamide |
| | 40% Reammide PAS 6 AP (Henkel s.p.a., Milan, Italy) |
| 13 | 70% 1,4-di(hydroxymethyl)benzene |
| | 30% Degalan LPAL 23 (Röhm America LLC, Piscataway |
| | NJ, USA) |
| 14 | 65% asymmetric bisamide according to Example 1(e) |
| | U.S. Pat. No. 5 421 868 |
| | 35% Vestamelt 640 (Degussa AG, Marl, Germany) |

This example describes a method of making a basic component for meltable inks. This resin-like component is a reaction product of di-isopropanolamine, benzoic acid and succinic acid anhydride. A 1-litre reaction flask was provided with a mechanical agitator, a thermometer, and a DeanStark rig. 261.06 g (1.960 mol) of di-isopropanol amine (type S, BASF), 540.88 g (4.429 mol) benzoic acid (Aldrich) and 69.69 g (0.696 mol) succinic acid anhyride (Aldrich) were introduced into the flask. A small quantity of o-xylene, approximately 60 ml, was added as entraining agent to remove the liberated water. The reaction mixture was kept in a nitrogen atmosphere and heated for 1 hour at 165° C., whereafter the reaction temperature was brought to 180° C. After 6 hours the temperature was reduced to 160° C. and the flask was evacuated to remove the o-xylene. It was possible to draw off the reaction mixture after about 1 hour. Analysis showed that the number-averaged molecular weight (Mₙ) of the component was 583 and the weight-averaged molecular weight (M_{w}) was 733.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A meltable ink which is solid at room temperature and liquid at elevated temperature, and used in combination with an inkjet printhead for the image-wise transfer of the ink to a receiving material, wherein the printhead comprises a number of ink ducts, each ink duct leading to an opening for jetting ink drops from said duct, which ducts are formed in a duct plate made basically from carbon, wherein the ink penetrates into the carbon in such a manner that if an element made from said carbon is enclosed by the ink for about 20 hours at a temperature of about 130° C., said element has an increase in mass of more than 1.5%.

2. The meltable ink according to claim 1, wherein the increase in mass is between 2.5 and 3%.

3. The meltable ink according to claim 1, wherein the ink comprises a crystalline basic material and an amorphous binder.

4. The meltable ink according to claim 1, wherein the ink ducts are controlled by the use of piezo-electric actuators which are operatively connected to the ducts via a vibration plate.

5. Use of a meltable ink solid at room temperature and liquid at elevated temperature, in an inkjet printhead for the image-wise transfer of the ink to a receiving material, wherein the printhead comprises a number of ink ducts each leading to an opening for jetting ink drops from the corresponding duct, which ducts are formed in a duct plate made basically from carbon, wherein the ink can penetrate into the carbon in such a manner that if an element made from said carbon is enclosed by the ink for about 20 hours at a temperature of about 130° C. said element has an increase in mass of more than 1.5%.

6. Use of a meltable ink composition which is solid at room temperature and liquid at elevated temperature for producing solid units of ink for use in an inkjet printer provided with a printhead for the image-wise transfer of the ink to a receiving material, wherein the printhead comprises a number of ink ducts each leading to an opening for jetting ink drops from the corresponding duct, which ducts are formed in a duct plate made essentially from carbon, wherein the ink can penetrate into the carbon in such manner that if an element made from said carbon is enclosed by the ink for about 20 hours at a temperature of about 130° C. said element has an increase in mass of more than 1.5%.

7. The meltable ink of claim 1 wherein the increase in mass is greater than 1.5% up to 3%.

8. An inkjet printhead having at least a part thereof made of carbon, which is penetrated with a meltable ink which penetrates into the carbon to such an extent that said carbon part has an increase in mass of more than 1.5%.

9. The inkjet printhead of claim 8, wherein the increase in mass is more than 1.5% up to about 3%.

10. The inkjet printhead of claim 8, wherein said printhead comprises a number of ink ducts, each duct leading to an opening for jetting ink drops from said duct, said ducts being formed in a duct plate, said duct plate being made of said carbon.

11. The ink jet printhead of claim 10, wherein only those parts of the duct plate which come in contact with the ink are made of carbon.
